(19) United States
(12) Patent Application Publication
(10) Pub. No.: US 2026/0104980 A1
(43) Pub. Date: Apr. 16, 2026

(54) GENERATING AND EXECUTING TEST CASES FOR CORE PERFORMANCE VERIFICATION

(71) Applicant: International Business Machines Corporation, Armonk, NY (US)

(72) Inventors: Gandhi Sodabathula, Miryalaguda (IN); Jang-Soo Lee, Poughkeepsie, NY (US); David Lee, Fishkill, NY (US)

(21) Appl. No.: 18/916,912

(22) Filed: Oct. 16, 2024

(51) Int. Cl. G06F 11/34; G06F 11/30

(52) U.S. Cl. CPC G06F 11/3476; G06F 11/3006

(57) ABSTRACT

According to a present invention embodiment, a trace collected during flow of instructions through an execution pipeline of one or more processors is received. The trace includes contents of registers and memory. One or more memory locations to be reset are determined from the trace based on performance of the instructions indicated within the trace. The test case is generated including indications of the one or more memory locations to be reset and corresponding contents for resetting the one or more memory locations. The test case is executed on one or more platforms a plurality of times to determine a performance measurement. The one or more memory locations are reset with the corresponding contents between executions of the test case on the one or more platforms.

### BACKGROUND

### 1. Technical Field

Present invention embodiments relate to core performance verification of computer systems, and more specifically, to generating and executing instruction sequence test cases derived from a hardware trace of a computer system that can repeatedly run on a core performance model, a very high speed integrated circuit (VHSIC) hardware description language (VHDL) simulator, and an actual machine and provide a steady-state infinite (cache) cycles per instructions (CPI) measurement that can be compared across platforms.

### 2. Discussion of the Related Art

Data processing systems may use virtual addressing in multiple virtual address spaces and include a central processing unit (CPU) and a main storage. The main storage is directly addressable and provides for high-speed processing of data by the CPU. Generally, address spaces reside in main storage and include a consecutive sequence of integer numbers (or virtual addresses) together with specific transformation parameters that allow each number to be associated with a byte location in storage. When a virtual address is used by a CPU to access main storage, the virtual address is converted by dynamic address translation (DAT) to a real address that is further converted to an absolute address by prefixing. Dynamic address translation (DAT) translates a virtual address of a computer system to a real address using translation tables.

Tracing assists in determining whether issues exist in the data processing system by providing an ongoing record in storage of significant events (or benchmarks). An example of a tracing system is the CMS Adjunct Tracing System (CATS) that includes a coherent, sequential and generally contiguous set of architected instruction records that are captured while processing instructions through a data processing system.

An extended in-memory trace (extended-IMT) further provides architected register contents and memory storage contents that are required to generate instruction sequence test cases. A CMD file is created that contains all initial contents of all the architecture registers and memory storage contents accessed by instructions in the extended-IMT using an IMT post-processing/verification tool. This CMD file is run on a test system (e.g., Vicom, etc.) to generate CATS instruction traces that are further fed to a sequence test case generator tool to generate the instruction sequence test cases.

However, this process provides various disadvantages. For example, time sensitive operations break the instruction sequence test case on a test system due to a timing difference from an original trace. Further, the IMT post-processing/verification tool is unable to correct memory data capture errors in an extended-IMT. Moreover, tracing on the test system introduces issues, including lack of support for newer instructions by a trace capture tool, and the trace capture tool may inject another set of errors where data content was incorrectly captured. In addition, a significant amount of time (e.g., days, etc.) may be needed to generate a single test case from a CMD file, thereby preventing scalability as there may be more than one thousand CMD files from a single benchmark program.

### SUMMARY

According to one embodiment of the present invention, a computer system for generating and executing a test case for performance verification of a computing system comprises one or more memories, and at least one processor coupled to the one or more memories. The computer system receives a trace collected during flow of instructions through an execution pipeline of one or more processors. The trace includes contents of registers and memory. One or more memory locations to be reset are determined from the trace based on behavior of the instructions indicated within the trace. The test case is generated including indications of the one or more memory locations to be reset and corresponding contents for resetting the one or more memory locations. The test case is executed on one or more platforms a plurality of times to determine a performance measurement. The one or more memory locations are reset with the corresponding contents between executions of the test case on the one or more platforms. Embodiments of the present invention further include a method and computer program product for generating and executing a test case for performance verification of a computing system in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a diagrammatic illustration of producing instruction traces and instruction sequence test cases according to an embodiment of the present invention.

FIG. 3 is a table associating records to core units for a trace according to an embodiment of the present invention.

FIG. 4 is a flow diagram of test case generation and performance verification according to an embodiment of the present invention.

FIG. 5 is procedural flowchart of a manner of generating instruction sequence test cases according to an embodiment of the present invention.

FIG. 6 is a procedural flowchart of a manner of identifying address translation information in extended-IMT data according to an embodiment of the present invention.

FIG. 7 is a flow diagram of instruction sequence test case verification according to an embodiment of the present invention.

### DETAILED DESCRIPTION

Data processing systems may use virtual addressing in multiple virtual address spaces and include a central processing unit (CPU) and a main storage. The main storage is directly addressable and provides for high-speed processing of data by the CPU. Generally, address spaces reside in main storage and include a consecutive sequence of integer numbers (or virtual addresses) together with specific transformation parameters that allow each number to be associated with a byte location in storage. When a virtual address is used by a CPU to access main storage, the virtual address is converted by dynamic address translation (DAT) to a real address that is further converted to an absolute address by prefixing. Dynamic address translation (DAT) translates a virtual address of a computer system to a real address using translation tables.

Tracing assists in determining whether issues exist in the data processing system by providing an ongoing record in storage of significant events (or benchmarks). An example of a tracing system is the CMS Adjunct Tracing System (CATS) that includes a coherent, sequential and generally contiguous set of architected instruction records that are captured while processing instructions through a data processing system. CATS is an application program of the CMS Adjunct facility and the Instruction Trace Facility (ITF) of VICOM. CATS, ITF and the VICOM/CMS Adjunct function as a system capable of simulating and recording all interrupts, intercepts and all instructions which occur during the operation of a program. This generates instruction traces that are fed into a performance model. CATS trace also provides register contents and memory contents that enabled us to generate sequence test cases. However, this approach has some drawbacks.

An IMT trace is a hardware-generated trace that doesn't have register and memory contents. An instruction trace converted from the IMT trace is called CATS.trace which doesn't provide all information that the VICOM CATS trace provided. The CATS.sub trace has enough information to drive a performance model. A tool (e.g., CSGEN—CATS.sub trace generator) processes an IMT trace and generates CATS.sub trace, an instruction trace in CATS trace format.

An extended in-memory trace (extended-IMT) further provides architected register contents and memory storage contents to generate instruction sequence test cases. The CSGEN tool functions as a code sequence generator as well as a CATS.sub trace generator.

An embodiment of the present invention verifies core performance by reconstructing benchmark execution paths with instruction sequence test cases generated from extended-IMT data. The instruction sequence test cases are generated for core performance verification on real hardware and on software simulated models (of hardware). This provides performance insights on continuously evolving applications running on a computer system. Hardware traces (or extended-IMT) providing initial register contents and memory data contents enable generation of instruction sequence test cases (e.g., z Systems® architecture, etc.) through reverse engineering of the traces. The instruction sequence test cases provide a consistent codes base for core performance verification that can run on different environments (e.g., a core performance model, a VHDL core simulator, a VHDL system simulator, early hardware bring-up, etc.).

An embodiment of the present invention gains the performance insights on continuously evolving applications running on a computer system. An extended in-memory trace (extended-IMT) with the memory references captured for a processor is initiated. The captured trace is fed to a post-processing/verification tool (e.g., CSGEN, etc.) for reverse engineering of these traces into instruction sequence test cases (e.g., z Systems® architecture, etc.). Core performance verification uses these test cases by running them on a VHDL core simulator model or on real hardware. The test case is also run on a VHDL core simulator in IMT mode to generate IMT data which are converted into CATS.sub trace that feeds into a core performance model. In this way, pre-silicon performance verification is conducted between the core performance model and VHDL simulator with the same instructions.

An embodiment of the present invention initiates an in-memory trace (IMT) data capture for a processor. The IMT data being an instruction trace collected while the instructions flow through an execution pipeline of the processor. The tracing is further enhanced to extended-IMT data that captures the initial contents of architected registers of the processor and memory storage contents that are referenced by instructions of a benchmark program.

An embodiment of the present invention generates instruction sequence test cases by identifying initial versus reset memory storage using a memory tag scheme, and runs the test cases to produce a steady-state infinite cycles per instructions (CPI) measurement (e.g., of cache cycles) for core performance verification. The steady-state infinite CPI (or infinite cache CPI) is measured by eliminating finite cache effect as much as possible so that the CPI can represent the performance of the test case when the test case runs with a majority of memory references being hit (e.g., in L1 or other caches). This enables a true (apple-to-apple) comparison of the CPI on a simulator and actual hardware that may have different cache miss latency.

The steady-state infinite CPI (e.g., of cache cycles or infinite cache CPI) can be obtained by executing a test case multiple times and restoring the initial architecture contents and memory storage contents referenced during test case execution at the end of each test case execution. The performance of the first execution iteration of the test case is ignored since there is a high probability of a significant number of cache misses. Thus, performance is measured from the second iteration of the test case to obtain the steady-state infinite CPI.

Restoring all memory storage contents that were referenced by a test case provides several disadvantages. For example, restoring instructions causes a storing into instruction stream event that produces a cache coherence event to invalidate the restored instructions in the instruction cache (I-cache). This also causes numerous I-cache misses for the next iteration of test case execution, thereby reducing processing performance. Further, some architectures (e.g., z Systems® architecture, etc.) allow an instruction to update the instruction stream. When this is not properly identified and restored at the end of each iteration, a different instruction stream may be used for the next iteration, thereby unnecessarily consuming computing resources for erroneous results. Moreover, failure to identify translation table contents being updated during test case execution requires all TLB contents to be erased since it is unknown which translation table contents were updated during test case execution. This violates steady-state infinite CPI that requires minimum cache and TLB misses.

In addition, restoring all operand data storages increases pollution of a data cache (D-cache) since more memory storage pulls through the D-cache (source and target). This can eject other data being used during test case execution from the D-cache, thereby causing more cache misses which violates minimum cache misses required for steady-state infinite CPI.

Accordingly, in order to restore the initial architecture contents and memory storage contents, a test case suite (e.g., complete automation package (CAP), etc.) control program of a present invention embodiment saves these contents in a test case suite memory storage that is not referenced by the test case, and copies (restores) the contents into the test case memory storage before executing the test case again. The embodiment further employs a memory tag scheme when processing extended-IMT data and generating an instruction sequence test case to restore only the data that needs restoration (as opposed to all memory locations). This addresses the disadvantages described above and increases cache hits (I-cache and D-cache) for increased processor performance.

An embodiment of the present invention executes the test case (generated from extended-IMT data) multiple times to produce the steady-state infinite CPI. The test case is loaded into a memory with a test case suite (e.g., CAP, etc.) control program only once, and run multiple times with minimum resetting activities to minimize cache pollution (e.g., due to resetting all memory storage being referenced by the test case regardless of the type of the memory operation, etc.) which is required to produce the steady-state infinite CPI. In other words, the amount of memory data being restored is minimized to avoid unnecessary cache pollution and produce the steady-state infinite CPI. The steady-state infinite CPI may be directly compared among a simulator, performance model, and hardware to simplify and improve efficiency for pre-silicon performance verification and post-RIT performance validation processes.

In order to measure the steady-state infinite CPI, execution cycles for an initial run of a test case are ignored since they experience numerous cache misses. In addition, the execution cycles consumed by the test case suite control program to restore memory contents are ignored. This enables the steady-state infinite CPI to be measured for the test case instructions running on steady state only.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

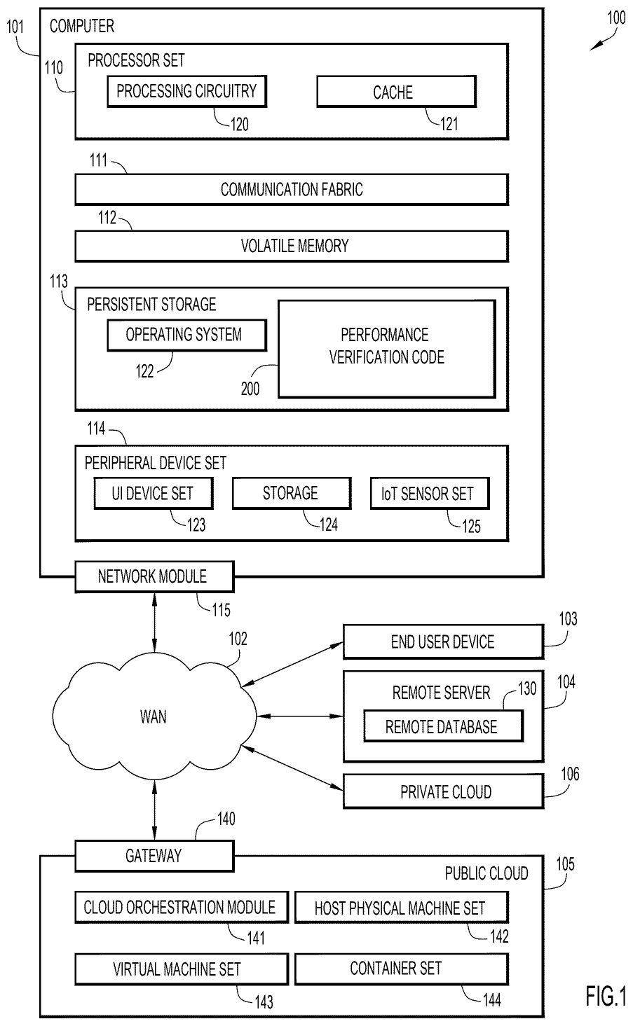

Referring to FIG. 1, computing environment 100 contains an example of an environment for the execution of at least some of the computer code involved in performing the inventive methods, such as performance verification code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Typically, addresses that an application program “sees” are often referred to as virtual addresses. Virtual addresses are sometimes referred to as “logical addresses” and “effective addresses”. These virtual addresses are virtual in that they are redirected to physical memory location by one of a variety of dynamic address translation (DAT) technologies including, but not limited to, simply prefixing a virtual address with an offset value, translating the virtual address via one or more translation tables, the translation tables preferably comprising at least a segment table and a page table alone or in combination, preferably, the segment table having an entry pointing to the page table. For example, in some processors, a hierarchy of translation is provided including a region first table, a region second table, a region third table, a segment table and an optional page table. The performance of the address translation is often improved by utilizing a translation lookaside buffer (TLB), which comprises entries mapping a virtual address to an associated physical memory location. The entries are created when the DAT translates a virtual address using the translation tables. Subsequent use of the virtual address can then utilize the entry of the fast TLB rather than the slow sequential translation table accesses. TLB content may be managed by a variety of replacement algorithms including LRU (Least Recently used).

In the case where a processor is a processor of a multi-processor system, each processor has responsibility to keep shared resources, such as I/O, caches, TLBs and memory, interlocked for coherency. Typically, “snoop” technologies are utilized in maintaining cache coherency. In a snoop environment, each cache line may be marked as being in any one of a shared state, an exclusive state, a changed state, an invalid state and the like in order to facilitate sharing.

The processor may be coupled in communication with a number of TLBs, which are cache memories that generally hold only translation table mappings. On every reference, the TLB is used to look up a virtual page number for the reference. If there is a hit, a physical page number is used to form the address, and the corresponding reference bit is turned on. If a miss in the TLB occurs, and if the referenced page exists in memory, the translation can be loaded from the page table in memory into the TLB and the reference can be tried again. If the page is not present in the memory, a page fault has occurred and the CPU must be notified with an exception.

In one embodiment, the TLBs include a first level TLB or “TLB1”, and a second level TLB or “TLB2” that supports the TLB1. In one embodiment, the TLB1 includes an instruction cache (I-cache) corresponding to an instruction TLB or “ITLB” and a data cache (D-cache) corresponding to a data TLB or “DTLB.”

The TLBs are described herein, by way of example, as an embodiment adapted to z Systems® architecture. This architecture uses TLB combined region-and-segment-table entries (CRSTE) connected to TLB page-table entries (PTE), where first regions, then segments and thereafter pages is the order in which address translation takes place. However, embodiments of the present invention can use TLBs adapted for any suitable computer architecture.

A data processing system, such as a computer server (e.g., computer 101, remote server 104, etc.), may capture in-memory trace (IMT) data that includes an instruction trace collected by hardware while instructions flow through an execution pipeline. Capturing the IMT data enables capture of traces with millicode instructions (e.g., a higher level of microcode for implementing an instruction set) for complex workloads. IMT data do not provide memory data contents. However, the data processing system may produce an extended in-memory trace (extended-IMT) that provides architected register contents and memory storage contents for generating instruction sequence test cases for a controlled test case suite (e.g., Complete Automation Package (CAP) test case suite, etc.). For example, data processing systems, such as z Systems® processor cores, may include a function of capturing hardware instruction traces as extended-IMT data. The test cases may be used for performance verification of processor cores by measuring/comparing steady-state infinite CPI on a core performance model, a core hardware description language (e.g. VHDL, etc.) simulator, and actual hardware.

By way of example, embodiments of the present invention are described with respect to an architecture of z Systems®. However, embodiments of the present invention can be used with any suitable computer architecture in substantially the same manner described below.

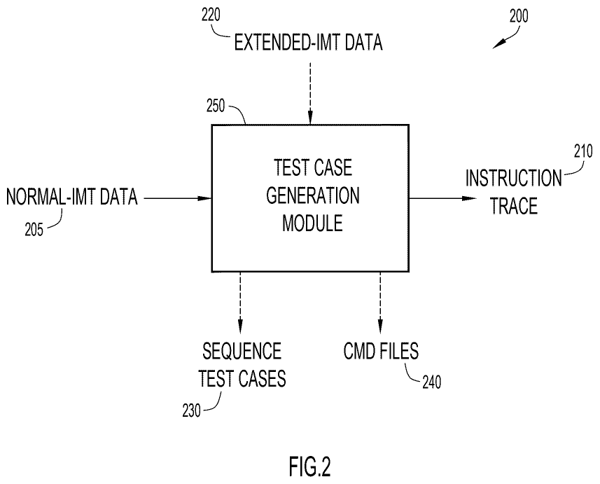

A manner of producing instruction traces and instruction sequence test cases (e.g., via computer 101, performance verification code 200, etc.) according to an embodiment of the present invention is illustrated in FIG. 2. Initially, performance verification code 200 may include a test code generation module 250. The test code generation module may include a verification tool (e.g., CATS.sub generator in-memory trace (IMT) verification Tool (CSGEN), etc.). Test code generation module code 250 may receive in-memory trace (IMT) data 205 from a tracing system (e.g., of computer 101, etc.). For example, data processing systems, such as z Systems® processor cores, may include a function of capturing hardware instruction traces as IMT data. The IMT data include an instruction trace collected by hardware while instructions flow through an execution pipeline, but do not provide memory data contents. Test case generation module 250 produces instruction traces 210 based on the IMT data that are provided to a core performance model as described below. The instruction traces may be of the same format as the CATS trace, but have portions of data missing relative to the CATS trace. The instruction trace converted from the IMT trace doesn't provide all information that the initial CATS trace provided. The instruction trace has enough information to drive a performance model.

Test case generation module 250 may receive extended-IMT data 220 from a tracing system (e.g., of computer 101). For example, data processing systems, such as z Systems® processor cores, may include a function of capturing hardware instruction traces as extended-IMT data. The extended-IMT data include architected register contents and memory storage contents in addition to IMT data. Test case generation module 250 produces instruction sequence test cases 230 and CMD files 240. A CMD file 240 contains all initial contents of all the architecture registers, and memory accessed by instructions in an instruction sequence test case 230 from test case generation module 250. This file is run on a test system (e.g., Vicom, etc.) to generate traces (e.g., CATS traces, etc.). The traces are further fed to an instruction sequence test case generator tool to generate instruction sequence test cases as described below. Instruction sequence test cases 230 are provided for execution on a core simulation model, system simulation model, and actual hardware for core performance verification as described below.

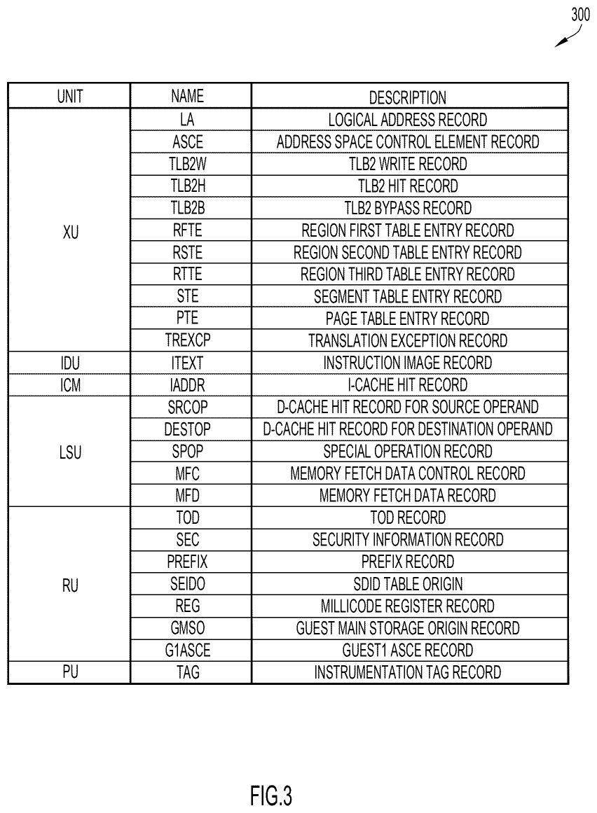

In one or more examples, IMT data is captured as a trace segment table, including a variety of record types. One or more record types may make up one or more trace record segments. These records may be created by different units, and may be stored, for example, in memory or other suitable location. For an instruction executed, a group of IMT records are collected. The number and type of records are dependent on the instruction type. For example, a memory instruction that results in fetching/storing operand results in the IMT data including SRCOP and/or DESTOP records (depending on the number of operands) (FIG. 3). If either instruction fetch or data fetch misses TLB1 then, all or some of the translation records (virtual address, etc.) are written depending on the page and/or region hit and level of translation table required for the address translation. Thus, a trace record segment typically refers to a group of IMT records written per instruction.

Records produced by core units for a trace according to an embodiment of the present invention are illustrated in FIG. 3. The types of IMT records that may be produced by the core units (e.g., of computer 101, etc.) for each instruction being executed for a trace are indicated in table 300. The data in the records are used to generate information for the test cases. The core units include a translation unit (XU) for translating between virtual and absolute addresses, an instruction decoding unit (IDU) for decoding instructions, an instruction cache unit (ICM) for monitoring instruction cache, a load store unit (LSU) for performing load and store operations, a recovery unit (RU) for managing register contents, and a pervasive unit (PU) that collects generated records.

By way of example, the translation unit (XU) may produce a logical address record (LA), an address space control element record (ASCE), a TLB2 write record (TLB2W), a TLB2 hit record (TLB2H), a TLB2 bypass record (TLB2B), a region first table entry record (RFTE), a region second table entry record (RSTE), a region third table entry record (RTTE), a segment table entry record (STE), a page table entry record (PTE), and/or a translation exception record (TREXCP).

The instruction decoding unit (IDU) may produce an instruction image record (ITEXT). The instruction cache unit (ICM) may produce an instruction cache (I-cache) hit record (IADDR). The pervasive unit (PU) may produce an instrumentation tag record (TAG).

The load store unit (LSU) may produce a data cache (D-cache) hit record for source operand (SRCOP), a D-cache hit record for destination operand (DESTOP), a special operation record (SPOP), a memory fetch data control record (MFC), and/or a memory fetch data record (MFD).

The recovery unit (RU) may produce a time of day record (TOD), a security information record (SEC), a prefix record (PREFIX), SDID table origin (SEIDO), a millicode register record (REG), a guest main storage origin record (GMSO), and/or a guest1 ASCE record (G1ASCE).

One or more records are written for each instruction being executed. For example, when an instruction is successfully decoded, the IDU writes an ITEXT record. The ICM unit writes an IADDR record for every instruction cache (I-cache) hit. Operand records, such as SRCOP and DESTOP records, are written by the LSU for every data cache (D-cache) hit. The XU unit is responsible for address translation that provides a fast lookup of already translated addresses in a translation lookaside buffer (TLB2). Thus, for every TLB2 hit, a TLB2H record is generated and, for every miss, LA and ASCE records along with table entry records, such as RFTE, RSTE, RTTE, STE, and PTE records, are written by the XU.

MFC, MFD records are responsible for providing operand data contents that are captured by the LSU. The MFC, MFD records are provided only for a memory fetch instruction (but not for a store instruction since the performance verification code may create an initial memory image, create the contents of the architected registers, track the accessing of memory byte using memory tags, and reinitialize to the initial state of memory during the breaking of the instruction sequence test case). The instruction sequence test cases are used for performance verification of new processor cores by measuring/comparing steady-state infinite cycles per instructions (CPI) on a core performance model, a core hardware description language (VHDL) simulator, and actual hardware.

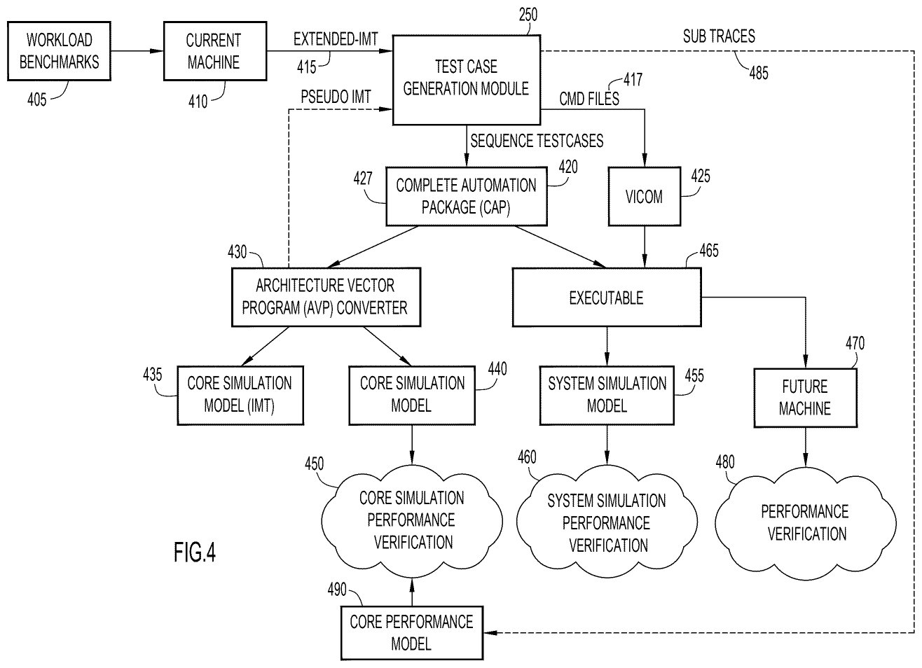

Test case generation and performance verification (e.g., via computer 101, performance verification code 200, etc.) according to an embodiment of the present invention is illustrated in FIG. 4. The presence of data contents in extended-IMT data enables performance verification of new customer workloads using new instruction sets which may be a crucial element for developing next-generation processor cores. Initially, a computing machine 410 (e.g., computer 101, remote server 104, etc.) executes one or more workload benchmarks 405 and captures extended-IMT data 415 during the execution in substantially the same manner described above. For example, data processing systems, such as z Systems® processor cores, may include a function of capturing hardware instruction traces as extended-IMT data. The extended-IMT data is used for generating sequence test cases 420 using test case generation module 250 (e.g., a CATS generator tool) of performance verification code 200. The CATS.sub traces are generated from the pseudo-IMT data generated by the core simulator running in IMT mode (and not from the extended-IMT data which are used to generate sequence test cases only). The CATS.sub trace may be of the same format as the CATS trace, but has portions of data missing relative to the CATS trace. The CATS.sub traces are used by a core performance model 490 of performance verification code 200 for generating CPI results being used for core simulation performance verification at flow 450.

Test case generation module 250 generates instruction sequence test cases 420 based on the extended-IMT data. CMD files 417 are also generated by the test case generation module from the extended-IMT data. The CMD files may be processed by a test system 425 (e.g., Vicom, etc.) of performance verification code 200 for checking successful execution and debugging of the sequence testcases (e.g., when a failure occurs, etc.).

Instruction sequence test cases 420 are provided to a test case suite 427 (e.g., complete automation package (CAP)) of performance verification code 200 that generates further test cases. The further test cases are provided to a converter 430 (e.g., architecture vector program (AVP) converter, etc.) of performance verification code 200 that produces a file (e.g., AVP file, etc.) containing initial contents of all architected registers and memory accessed by instructions in a test case for execution on a core simulator (e.g., VHDL simulator, etc.). The file is provided to a core simulation model 440 of performance verification code 200 simulating the core (without producing IMT data). The core simulation model may be a model that simulates a processor and/or hardware components being tested (e.g., a VHDL simulated model, etc.). The results (or steady-state infinite CPI) is provided for core simulation performance verification (based on results from core performance model 490) at flow 450. By way of example, the core performance verification may be performed by comparing outputs (e.g., steady-state infinite CPI, etc.) from simulation model 440 (without IMT data) to outputs (e.g., steady-state infinite CPI, etc.) from performance model 490. The verification may be considered successful when the outputs match or a difference between the outputs is within a threshold or tolerance.

The file from converter 430 is also provided to a core simulation model 435 of performance verification code 200 simulating the core (and producing IMT data). The resulting simulated or pseudo-IMT data is provided back to test case generation module 250 for processing. The pseudo-IMT data is used to develop test case generation module 250 (e.g., an IMT verification tool) that is used to verify the IMT content at a development stage before an actual machine is available. The pseudo-IMT data from the core simulator model (running in IMT mode) is not just for IMT content verification but also generate CATS.sub traces for sequence test cases to drive a core performance model so that apple to apple comparison of the output from the VHDL simulator and performance model.

The further test cases from test case suite 427 are also used to form an executable 465 that is run on system simulation model 455 of performance verification code 200 and a future computing machine 470 (e.g., machine under development, prototype, hardware version, etc.). The system simulation model may be a model that simulates a processor and other hardware components of the system being tested. The results from the system simulation model are used for system simulation performance verification at flow 460. The results from the future computing machine are used for performance validation at flow 480. By way of example, the system simulation performance verification and performance validation may be performed by comparing outputs (e.g., steady-state infinite CPI, etc.) from system simulation model 455 to outputs (e.g., steady-state infinite CPI, etc.) from future machine 470. The verification or validation may be considered successful when the outputs match or a difference between the outputs is within a threshold or tolerance.

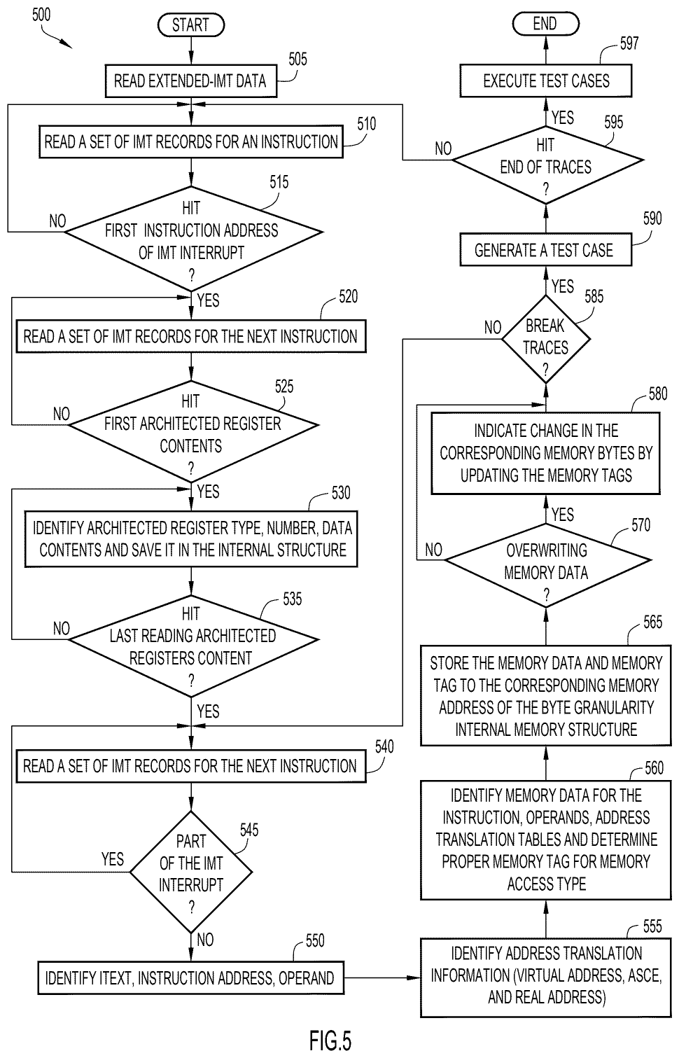

A method of generating instruction sequence test cases (e.g., via computer 101, performance verification code 200, etc.) according to an embodiment of the present invention is illustrated in FIG. 5. In an ideal scenario, IMT (or extended-IMT) capture is stopped at every break point and started again by capturing initial contents of the architected registers. However, this type of IMT capture is costly to implement because it requires hardware to monitor/decode instructions to identify potential instructions causing break points.

Accordingly, an embodiment of the present invention captures the initial contents (snapshot) of the architected registers at any desired number of instructions (e.g., 2000 instructions, 4000 instructions, etc.) using an IMT interrupt. A break point may be identified (or occur) in various manners based on changes in program behavior, including causing an I/O instruction, external interrupts, time dependent store location instructions not providing enough information for test case generation, etc. A test case ends with a break point which includes a fetch from a time dependent store location, an I/O instruction, external interrupts, an instruction not providing enough information for test case generation, etc. In order to generate multiple test cases from extended-IMT data, an IMT interrupt that writes/reads architected registers is injected at completion of desired number of instructions (e.g., 2000 instructions, 4000 instructions, etc.). When a test case needs to be stopped at a break point, a next test case can start right after the next IMT interrupt. In other words, when a break point is identified, generation of an instruction sequence test case is stopped and a next test case can be started at a next IMT interrupt that provides a snapshot of the architectural registers.

Extended-IMT data is read at operation 505. The information to enable instruction execution on a VHDL simulator or real hardware is collected. An initial memory image may be constructed based on the generated records (FIG. 3). The LSU provides MFC and MFD records for all data fetched from memory, and performance verification code 200 constructs the initial memory image with the ITEXT record, operand data, and translation tables provided in the extended-IMT data.

Initial contents of architected registers (e.g., CR, GR, AR, FPR, PREFIX, FPC, PSW, etc.) are collected based on a millicode routine (e.g., higher level microcode servicing the interrupt) that writes architected register contents into a pre-defined memory address or location and reads them back from the same memory location. The LSU provides MFD/MFC records with the addresses of the pre-defined memory location. The performance verification code collects initial contents of architected registers that are mapped to the pre-defined memory addresses.

A set of IMT records (FIG. 3) for an instruction in the trace is read at operation 510. One or more records may be generated for each instruction as described above depending on the type of operation. The IMT records for the instruction are read until an instruction address corresponds to a first IMT interrupt as determined at operation 515. The first IMT interrupt corresponds to the millicode saving the architected registers (and prior to execution of the program under trace).

When the instruction address corresponds to the first IMT interrupt, a set of IMT records (FIG. 3) for a next instruction in the trace is read at operation 520. The IMT records for the next instruction are read until contents for a first architected register are encountered as determined at operation 525. This corresponds to saving the register contents by the millicode.

In order to generate the instruction sequence test cases, test case generation module 250 of performance verification code 200 internally maintains an instruction cache, a data cache, and TLB2 structures for determining address translation based on the type of IMT records that are written for each instruction being executed. The test case generation module further constructs an internal data structure holding initial contents of architected registers, such as control registers (CR), group registers (GR), access registers (AR), floating point registers (FPR), floating point control registers (FPC), prefix, program status word (PSW), and a double linked list structure of a memory space (e.g., memory storage being accessed during execution) allowing byte-granularity accesses. Any memory byte being accessed maintains a proper memory tag as described below. However, the data structure and double linked list may be implemented by any conventional or other data or storage structures.

When contents for a first architected register are encountered, the architected register, type, number, and data contents are identified and saved in the internal data structure at operation 530. This is repeated until the last instruction reading content for the architected registers is encountered as determined at operation 535.

When the last instruction reading the architected register content is encountered, a set of IMT records (FIG. 3) for a next instruction in the trace is read at operation 540. The IMT records for the next instruction are read until the records are no longer part of the IMT interrupt (e.g., a first program instruction has been encountered after the IMT interrupt, etc.) as determined at operation 545.

When the records are no longer part of the IMT interrupt (e.g., a program instruction has been encountered after the IMT interrupt, etc.), an ITEXT record, instruction address, and operand are identified from the IMT records at operation 550. The instruction may have used a virtual address. In this case, the IMT records may indicate a cache miss (for the virtual address look-up) and include additional records for translating the virtual address to a real and/or absolute address. When a cache miss for a virtual address occurs, address translation information (e.g., virtual address, ASCE record, real address, etc.) are identified from the IMT records at operation 555.

Test case generation module 250 constructs the internal data structure for memory storage contents as described above. These items are maintained in the internal data structure at a byte-granularity, where each memory byte that was referenced has a proper memory tag assigned for the corresponding memory reference activity/behavior. By way of example, the memory tags may include: TAG_ITEXT, when the memory byte contains an ITEXT record; TAG_FETCH, when the memory byte is being fetched; TAG_STORE, when the memory byte is being stored; TAG_CHANGE, where TAG_FETCH is changed to TAG_CHANGE when the memory byte is being stored after being fetched; TAG_FETCH_STORE, when the memory byte is being fetched and stored by the same instruction; and memory tags for address transaction table data (e.g., TAG_PTE, TAG_STE, TAG_DAT, etc.).

Initial memory tags may include TAG_ITEXT, TAG_FETCH, TAG_STORE, TAG_DAT, and memory tags for address transaction table data (e.g., TAG_PTE, TAG_STE, TAG_DAT, etc.), while memory tags for resetting memory may include TAG_CHANGE, and TAG_FETCH_STORE. The memory tags may further include a special memory tag to indicate a memory byte that was stored by any time dependent operand (e.g., store clock, etc.). An end of a test case may be indicated when a byte having a time dependent operand is referenced by any instruction.

The memory data for the instruction, operands, and address translation tables are identified, and the proper memory tag for the memory access type is determined at operation 560. The memory data and memory tag are stored to the corresponding memory address of the byte in the internal data structure at operation 565. The tags basically indicate whether or not data is static or read only (e.g., initial memory tags indicating data not needing to be reset for another iteration of the test case), or modifiable or updated (e.g., memory tags indicating data needing to be reset for another iteration of the test case) based on the activity or behavior.

When memory data is being overwritten (or updated) by an instruction as determined at operation 570 based on the IMT records, the change is indicated in the corresponding memory bytes by updating the memory tags in the internal data structure at operation 580.

An embodiment of the present invention captures the initial contents (snapshot) of the architected registers every desired number of instructions (e.g., 2000 instructions, 4000 instructions, etc.) using an IMT interrupt. A break point may be identified (or occur) in various manners based on changes in program behavior, including causing an I/O instruction, external interrupts, time dependent store location instructions not providing enough information for test case generation, etc. When a break point is identified, generation of an instruction sequence test case is stopped and a next test case can be started at a next IMT interrupt that provides a snapshot of the architectural registers.

Accordingly, the above process is repeated from operation 540 until a break point in the trace occurs as determined at operation 585. When the break point in the trace occurs, a test case is generated at operation 590 (for the instruction sequence encountered in the trace). The test case preferably includes various sections for information. By way of example, the test case includes: a section for initial contents of all architected registers, an initial address (IA) section for memory addresses that are only fetched or only stored during the execution of the test case; a reset initial address (Reset IA) section for memory addresses that are initially fetched and stored later during the execution of the test case; an initial data section for memory data corresponding to the initial memory addresses; and/or a reset data section for memory data corresponding to the reset memory addresses.

When processing of the extended-IMT data encounters a break point or other condition to generate a test case, the memory tags of the internal data structure are examined to identify addresses that need to be restored or reset at the end of test case execution. Accordingly, test code generation code 250 identifies initial storage bytes and reset storage bytes based on the memory tag information for those bytes (e.g., initial memory tags include TAG_ITEXT, TAG_FETCH, TAG_STORE, and memory tags for address transaction table data (e.g., TAG_PTE, TAG_STE, TAG_DAT, etc.), while reset memory tags include TAG_CHANGE and TAG_FETCH_STORE). The storage addresses and data are stored in the corresponding sections of the test case.

The above process is repeated from operation 510 until the traces have been processed and corresponding test cases have been generated as determined at operation 595. Once the test cases are generated, the test cases may be executed by simulators and/or hardware for performance verification at operation 597. For example, a steady-state infinite CPI may be measured for a test case by eliminating finite cache effect as much as possible so that the CPI can represent the performance of the test case when the test case runs with a majority of memory references being hit in caches. This enables a true (apple-to-apple) comparison of the CPI on a simulator and actual hardware that may have different cache miss latency.

The steady-state infinite CPI can be obtained by executing the test case multiple times and restoring the initial architecture contents and memory storage contents referenced during test case execution at the end of each test case execution. The performance of the first execution iteration of the test case is ignored since there is a high probability of a significant number of cache misses. Thus, performance is measured from the second iteration of the test case (and any quantity of additional successive executions) to obtain the steady-state infinite CPI.

The test case is loaded into a memory by a test case suite (e.g., a complete automation package program (CAP), etc.) control program of present invention embodiment and run multiple times with minimum resetting activities to minimize cache pollution (e.g., due to resetting all memory storage being referenced by the test case regardless of the type of the memory operation, etc.) which is required to produce the steady-state infinite CPI. In other words, the amount of memory data being restored is minimized to avoid unnecessary cache pollution and produce the steady-state infinite CPI.

In order to restore the initial architecture contents and memory storage contents, the control program saves these contents in a test case suite memory storage that is not referenced by the test case, and copies (restores) the contents into the test case memory storage before a next iteration of executing the test case. The sections of the test case indicate the memory locations that need to be reset after an execution iteration of the test case. For example, the reset addresses (Reset IA) in the test case indicate the memory locations that changed in the trace during execution of instructions and need to be reset, and the reset data section of the test case indicates the data to be stored in corresponding reset addresses for the next execution iteration of the test case. The initial addresses (IA) of the test case indicate the memory locations with data that remained static or unchanged (e.g., data that was only read and/or initialized, etc.) in the trace during execution of instructions and do not need to be reset, where the initial data section of the test case indicates the data to be stored in corresponding initial addresses (typically for the first execution of the test case). The CPI may be directly compared among a simulator, performance model, and hardware.

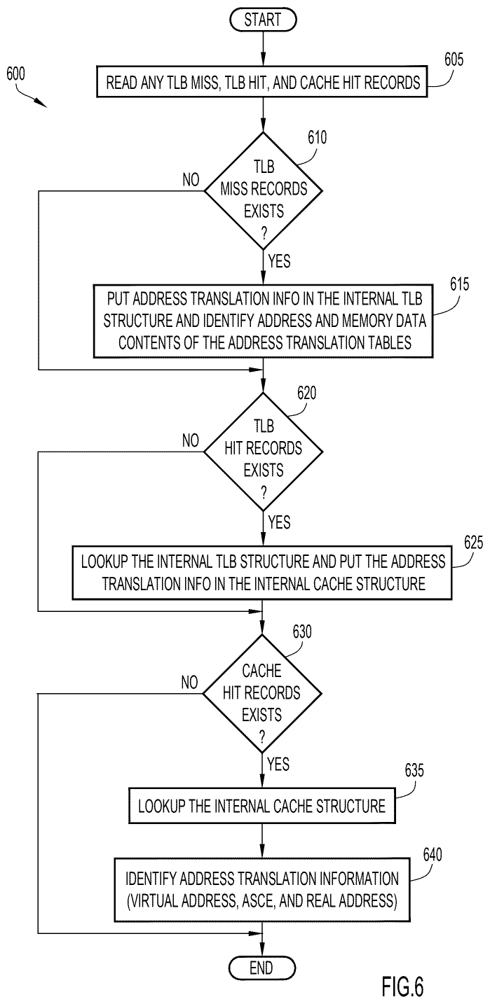

A method 600 of identifying address translation information in extended-IMT data (e.g., via computer 101, performance verification code 200, etc.) according to an embodiment of the present invention is illustrated in FIG. 6. Method 600 may correspond to operation 555 of FIG. 5. Initially, an ITEXT record, instruction address record (ITLB), and operand records (SRCOP and DESTOP) may be identified for a program instruction from IMT records as described above. Records for a TLB miss, TLB hit, and cache hit are read at operation 605. When TLB miss records exist as determined at operation 610, address translation information from the TLB miss records is placed in the internal TLB data structure, and the address and memory contents of the address translation tables are identified from the TLB miss records at operation 615.

When TLB hit records exist as determined at operation 620, a look-up is performed in the internal TLB data structure for the address translation information, and the information is placed in the internal cache data structure at operation 625.

When cache hit records exist as determined at operation 630, a look-up is performed in the internal cache data structure at operation 635, and corresponding address translation information (e.g., virtual address, ASCE record, real address, etc.) is identified at operation 640. The identified translation information is used to assign a memory tag as described above.

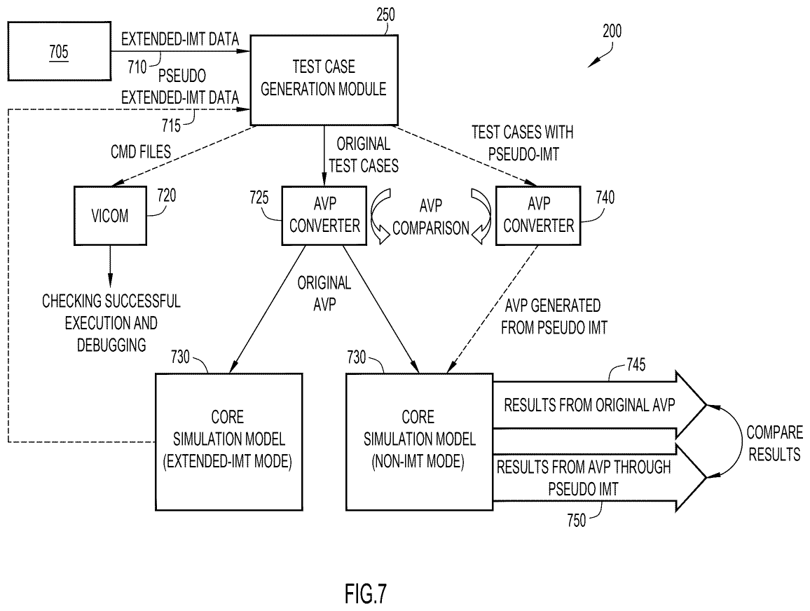

Instruction sequence test case verification (e.g., via computer 101, performance verification code 200, etc.) according to an embodiment of the present invention is illustrated in FIG. 7. Initially, a computing machine or system 705 (e.g., computer 101, remote server 104, etc.) executes one or more workload benchmarks and captures extended-IMT data 710 during the execution in substantially the same manner described above. For example, data processing systems, such as z Systems® processor cores, may include a function of capturing hardware instruction traces as extended-IMT data. Test case generation module 250 of performance verification code 200 generates original test cases based on the extended-IMT data from computing machine 705 in substantially the same manner described above. In addition, test case generation module 250 may generate pseudo test cases from extended-IMT data generated by a core simulation model 730 (pseudo extended-IMT data) as described below.

Moreover, test case generation module 250 may generate CMD files that contain all initial contents of all the architecture registers, and memory accessed by instructions in instruction sequence test cases from test case generation module 250. The test case generation module may include a verification tool (e.g., a CATS.sub trace generator in-memory trace (IMT) verification Tool (CSGEN), etc.). This file is run on a test system 720 (e.g., Vicom, etc.) for checking successful execution of the test cases and debugging of the test cases (e.g., when the verification fails, etc.).

The original test cases are provided to a converter tool 725 (e.g., architecture vector program (AVP) converter tool, etc.) of performance verification code 200 to generate a file (e.g., AVP file, etc.). An AVP file contains initial contents of all architected registers and memory accessed by the instructions in the test cases. The AVP file can run on a core simulator (e.g., VHDL core simulator, etc.). The file for the original test cases is run on a VHDL or other core simulation model 730 of performance verification code 200 in an extended-IMT mode that generates pseudo extended-IMT data 715. The core simulation model may be a model that simulates a processor and/or hardware components being tested (e.g., a VHDL simulation model, etc.). The core simulation model runs in different modes including a non-IMT mode and an extended-IMT mode. Pseudo-IMT data is generated when operating in the extended-IMT mode (e.g., non-IMT mode is not able to generate IMT data). The core simulator operates in the non-IMT (or regular) mode for general performance analysis. The pseudo extended-IMT data is provided to test case generation module 250 to produce pseudo test cases using simulated extended-IMT data. Initial pseudo extended-IMT data may be generated from core simulation model 730 using an initial pre-existing AVP file.

The pseudo test cases are provided to a converter tool 740 (e.g., architecture vector program (AVP) converter tool, etc.) of performance verification code 200 to generate a file (e.g., AVP file, etc.). An AVP file contains initial contents of all architected registers and memory accessed by the instructions in the pseudo test cases. The AVP file can run on a core simulator (e.g., VHDL core simulator, etc.).

The AVP files for the original and pseudo test cases are compared to verify the original test cases (e.g., the original test cases derived from computing machine 705 are compared to the pseudo test cases derived from core simulation model 730). For example, the file (e.g., AVP file) for the original test cases from converter tool 725 is also provided to core simulation model 730 of performance verification code 200 (in a non-IMT mode) that produces results 745 (without providing extended-IMT data). The file (e.g., AVP file, etc.) for the pseudo test cases from converter tool 740 is provided to core simulation model 730 (in non-IMT mode) that produces results 750 (without providing extended-IMT data). The results from the original test cases and pseudo test cases are compared to verify instruction sequence test cases. For example, when the results of test cases (e.g., steady-state infinite CPI, etc.) match or are within a threshold or tolerance of each other, the original test cases are considered to be verified.

It will be appreciated that the embodiments described above and illustrated in the drawings represent only a few of the many ways of implementing embodiments for generating and executing test cases for core performance verification.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., performance verification code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., performance verification results, CPI or other performance measurements, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., performance verification results, CPI or other performance measurements, etc.).

The present invention embodiments are not limited to the specific tasks or algorithms described above, but may be utilized for performance verification of any hardware component or architecture.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of generating and executing a test case for performance verification of a computing system comprising:
receiving, via at least one processor, a trace collected during flow of instructions through an execution pipeline of one or more processors, wherein the trace includes contents of registers and memory;
determining from the trace, via the at least one processor, one or more memory locations to be reset based on behavior of the instructions indicated within the trace;
generating, via the at least one processor, the test case including indications of the one or more memory locations to be reset and corresponding contents for resetting the one or more memory locations; and
executing the test case on one or more platforms a plurality of times to determine a performance measurement and resetting the one or more memory locations with the corresponding contents between executions of the test case on the one or more platforms.

2. The method of claim 1, wherein the performance measurement includes steady-state infinite cycles per instructions.

3. The method of claim 1, wherein the one or more platforms include a core simulator, a system simulator, and real hardware.

4. The method of claim 1, further comprising:
tagging, via the at least one processor, the one or more memory locations to be reset with tags indicating resetting of the one or more memory locations; and
generating, via the at least one processor, the test case based on the tags.

5. The method of claim 1, wherein the test case includes initial contents of architected registers, memory addresses with unchanged data during execution of the test case and corresponding data, and memory addresses with changed data during execution of the test case to be reset and corresponding data.

6. The method of claim 1, wherein executing the test case comprises:
executing the test case on a plurality of different platforms the plurality of times to determine the performance measurement; and
comparing the performance measurement from the plurality of different platforms to verify performance.

7. The method of claim 1, wherein the one or more locations to be reset are determined based on address translation information when a virtual address is indicated in the trace.

8. A computer system for generating and executing a test case for performance verification of a computing system comprising:
one or more memories; and
at least one processor coupled to the one or more memories and configured to:
receive a trace collected during flow of instructions through an execution pipeline of one or more processors, wherein the trace includes contents of registers and memory;
determine from the trace one or more memory locations to be reset based on behavior of the instructions indicated within the trace;
generate the test case including indications of the one or more memory locations to be reset and corresponding contents for resetting the one or more memory locations; and
execute the test case on one or more platforms a plurality of times to determine a performance measurement and reset the one or more memory locations with the corresponding contents between executions of the test case on the one or more platforms.

9. The computer system of claim 8, wherein the performance measurement includes steady-state infinite cycles per instructions.

10. The computer system of claim 8, wherein the one or more platforms include a core simulator, a system simulator, and real hardware.

11. The computer system of claim 8, wherein the at least one processor is further configured to:
tag the one or more memory locations to be reset with tags indicating resetting of the one or more memory locations; and
generate the test case based on the tags.

12. The computer system of claim 8, wherein the test case includes initial contents of architected registers, memory addresses with unchanged data during execution of the test case and corresponding data, and memory addresses with changed data during execution of the test case to be reset and corresponding data.

13. The computer system of claim 8, wherein the one or more locations to be reset are determined based on address translation information when a virtual address is indicated in the trace.

14. A computer program product for generating and executing a test case for performance verification of a computing system, the computer program product comprising one or more computer readable storage media having program instructions collectively stored on the one or more computer readable storage media, the program instructions executable by at least one processor to cause the at least one processor to:
receive a trace collected during flow of instructions through an execution pipeline of one or more processors, wherein the trace includes contents of registers and memory;
determine from the trace one or more memory locations to be reset based on behavior of the instructions indicated within the trace;
generate the test case including indications of the one or more memory locations to be reset and corresponding contents for resetting the one or more memory locations; and
execute the test case on one or more platforms a plurality of times to determine a performance measurement and reset the one or more memory locations with the corresponding contents between executions of the test case on the one or more platforms.

15. The computer program product of claim 14, wherein the performance measurement includes steady-state infinite cycles per instructions.

16. The computer program product of claim 14, wherein the one or more platforms include a core simulator, a system simulator, and real hardware.

17. The computer program product of claim 14, wherein the program instructions further cause the at least one processor to:
tag the one or more memory locations to be reset with tags indicating resetting of the one or more memory locations; and
generate the test case based on the tags.

18. The computer program product of claim 14, wherein the test case includes initial contents of architected registers, memory addresses with unchanged data during execution of the test case and corresponding data, and memory addresses with changed data during execution of the test case to be reset and corresponding data.

19. The computer program product of claim 14, wherein the program instructions further cause the at least one processor to:
execute the test case on a plurality of different platforms the plurality of times to determine the performance measurement; and
compare the performance measurement from the plurality of different platforms to verify performance.

20. The computer program product of claim 14, wherein the one or more locations to be reset are determined based on address translation information when a virtual address is indicated in the trace.
